(19) United States
(12) Patent Application Publication
(10) Pub. No.: US 2026/0169751 A1
(43) Pub. Date: Jun. 18, 2026

(54) APPARATUS AND METHOD FOR INSTRUCTION PROCESSING IN COMPUTATION ACCELERATOR

(71) Applicant: ELECTRONICS AND TELECOMMUNICATIONS RESEARCH INSTITUTE, Daejeon (KR)

(72) Inventor: Yeong Min LEE, Daejeon (KR)

(21) Appl. No.: 19/403,724

(22) Filed: Nov. 28, 2025

(30) Foreign Application Priority Data
Dec. 12, 2024 (KR) 10-2024-0184734
Nov. 4, 2025 (KR) 10-2025-0164144

(51) Int. Cl. G06F 9/38; G06F 9/30

(52) U.S. Cl. CPC G06F 9/3838; G06F 9/3001; G06F 9/30036

(57) ABSTRACT

A method and an apparatus are disclosed for instruction processing in a computation accelerator. The instruction processing apparatus includes an input unit configured to acquire instructions of a computation accelerator, a timing controller configured to issue control signals of the instructions, and an output unit configured to deliver the control signals of the instructions to all or a part of components within the computation accelerator. Here, the instructions include a first instruction and a second instruction executed after the first instruction. The timing controller calculates a wait cycle of the second instruction based on whether the first instruction is a variable-cycle instruction, or, when the first instruction is not the variable-cycle instruction, based on whether there is a dependency between the first instruction and the second instruction, and issues a control signal of the second instruction based on the wait cycle.

### CROSS-REFERENCE TO RELATED APPLICATIONS

This application claims priority to and the benefit of Korean Patent Application No. 10-2024-0184734, filed on Dec. 12, 2024, and Korean Patent Application No. 10-2025-0164144, filed on Nov. 4, 2025, the entire contents of each of which are incorporated herein by reference.

### BACKGROUND

### 1. Technical Field

The present disclosure relates to an apparatus and a method for instruction processing in a computation accelerator, and more particularly, to an apparatus and a method for efficiently processing operation instructions in a matrix computation accelerator.

### 2. Description of Related Art

The statements in this section merely provide background information related to the present disclosure and do not necessarily constitute prior art.

A main computation of artificial neural networks consists of large-scale matrix and vector operations. In order to improve the efficiency of computations in artificial neural networks, a dedicated hardware accelerator is being developed. A matrix processor (or matrix engine) primarily utilizes instruction sets for processing various operations such as vector addition, subtraction, multiplication, matrix multiplication, floating point operations, activation functions or the like.

Instructions within the accelerator must be processed sequentially due to inter-operation dependencies, which may cause a bottleneck where instructions cannot be executed every cycle. As a countermeasure for resolving inter-operation dependencies, complex scheduling algorithms or hardware designs may be introduced. However, the above-described countermeasures have limitations of implementation complexity for algorithms or hardware designs and additional consumption of hardware resources.

A matrix computation accelerator for artificial neural network has different characteristics from conventional general-purpose computation accelerator processors in terms of inter-operation dependencies. Therefore, there is a need for a method of efficiently processing operation instructions in a matrix computation accelerator in order to resolve inter-operation dependencies.

### SUMMARY

The present disclosure is directed to providing a high-level structure of a computation accelerator for efficiently processing operation instructions.

The present disclosure provides an instruction processing apparatus and a method for calculating and minimizing inter-instruction wait cycles by utilizing execution cycle latency and dependency information of each instruction in a computation accelerator.

The present disclosure aims to provide a method for verifying the structure and instruction processing method of a computational accelerator.

At least one aspect of the present disclosure provides a apparatus for instruction processing. The instruction processing apparatus includes an input unit configured to acquire instructions of a computation accelerator. Here, the instructions comprise a first instruction and a second instruction executed after the first instruction. The instruction processing apparatus also includes a timing controller configured to issue control signals of the instructions. The instruction processing apparatus also includes an output unit configured to deliver the control signals of the instructions to all or a part of components within the computation accelerator. The timing controller calculates a wait cycle of the second instruction based on whether the first instruction is a variable-cycle instruction, or, when the first instruction is not the variable-cycle instruction, based on whether there is a dependency between the first instruction and the second instruction, and issues a control signal of the second instruction based on the wait cycle.

Another aspect of the present disclosure provides a computation accelerator. The computation accelerator includes a timing controller configured to issue control signals of instructions. Here, the instructions comprise a first instruction and a second instruction executed after the first instruction. The computation accelerator also includes an inner product unit configured to perform an inner product operation based on the control signals. The computation accelerator also includes a vector engine configured to perform a vector operation based on the control signals. The timing controller calculates a wait cycle of the second instruction based on whether the first instruction is a variable-cycle instruction, or, when the first instruction is not the variable-cycle instruction, based on whether there is a dependency between the first instruction and the second instruction, and issues a control signal of the second instruction based on the wait cycle.

As described above, the present disclosure provides a structure of a computation accelerator for efficiently processing operation instructions. Thus, the structure of a computation accelerator approaches resolution of dependencies by utilizing simplified information of instructions at a high-level structure.

The present disclosure provides an instruction processing apparatus and a method for calculating and minimizing inter-instruction wait cycles by utilizing execution cycle latency and dependency information of each instruction in a computation accelerator. Thus, the instruction processing apparatus and the method sequentially process instructions in a short time.

In addition, the present disclosure provides a method for verifying the structure and instruction processing method of a computational accelerator. Thus, the verification method increases utilization of hardware resources, improves a speed of operation processing, and simplifies a design and verification process of the accelerator.

### BRIEF DESCRIPTION OF THE DRAWINGS

FIG. 1 is an exemplary diagram showing a high-level structure of a computation accelerator according to an embodiment of the present disclosure.

FIG. 2 is a flowchart schematically showing a process of processing an instruction according to an embodiment of the present disclosure.

FIG. 3 is an exemplary diagram showing a wait cycle according to an embodiment of the present disclosure.

FIG. 4 is an exemplary diagram schematically showing a verification apparatus according to an embodiment of the present disclosure.

FIG. 5 is a flowchart schematically showing a verification method according to an embodiment of the present disclosure.

FIG. 6 is a block diagram schematically showing an exemplary computing device that may be used to implement the apparatuses and methods described in the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The detailed description set forth below in conjunction with the accompanying drawings is intended to illustrate exemplary embodiments of the invention and is not intended to represent the only embodiments in which the invention may be practiced.

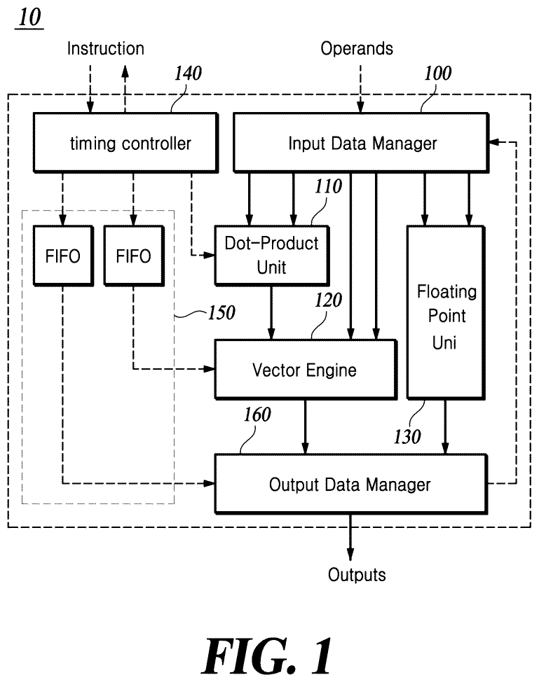

FIG. 1 is an exemplary diagram showing a high-level structure of a computation accelerator according to an embodiment of the present disclosure.

A computation accelerator 10 is a hardware device capable of performing specific types of operations such as matrix operations, vector operations, floating point operations, and the like, in parallel and at high speed, in contrast to a general-purpose processor (CPU). The computation accelerator 10 may be utilized in a variety of applications such as artificial intelligence inference, high-speed signal processing, computer vision and the like.

The computation accelerator 10 may be referred to as an accelerator, a hardware accelerator, a processing engine, a matrix computation accelerator, an AI/neural network accelerator, a vector matrix engine (VME), a vector processor, or the like. The computation accelerator 10 as used in the present specification may be understood as a concept encompassing various types of operation processing devices.

The computation accelerator 10 may include one or more of an input data manager (IDM) 100, an inner product unit (IPU) 110, a vector engine (VE) 120, a floating point unit (FPU) 130, a timing controller 140, a first-in first-out unit (FIFO unit) 150, and an output data manager (ODM) 160.

The input data manager 100 may receive data to be input into the computation accelerator 10. The inner product unit 110 may receive vector data and may perform multiplication and accumulation operations between vectors. The vector engine 120 may receive vector-type data and may perform various arithmetic and logical operations. The floating-point unit 130 may perform real-number operations according to a floating-point format. The timing controller 140 may control overall operation timing of the accelerator. The FIFO unit 150 may align data flow and instruction timing of the accelerator. The output data manager 160 may receive computation results of the input data.

The input data manager 100 may receive data to be input into the computation accelerator 10 from an external memory or an upper module. The input data manager 100 may be implemented as a first-in first-out buffer, a multiplexer (MUX), a demultiplexer (DEMUX), a direct memory access (DMA) controller, or an static random access memory (SRAM)-based input buffer. The input data manager 100 may be designed based on an interface protocol such as AXI or AHB. The input data manager 100 may include a data alignment unit and a data type conversion unit. For example, the input data manager 100 may perform type conversion, data structure conversion, or alignment of input data into a form required by the inner product unit 110 and the vector engine 120, and may deliver the input data to the inner product unit 110 and the vector engine 120. The input data manager 100 may be referred to as an input buffer, an input loader, an input interface module, a data fetcher, or the like.

The inner product unit 110 receives two pieces of vector data and performs multiplication and accumulation operations between the vectors. The inner product unit 110 may perform matrix multiplication, convolution, or inner product, and may perform multi-dimensional operations. The inner product unit 110 may include a plurality of multipliers and accumulators. The inner product unit 110 may be configured as an operation pipeline based on single instruction multiple data (SIMD) processing, and may be implemented as a multiply and accumulate (MAC) unit.

The vector engine 120 is an SIMD-based operation unit configured to process a plurality of operations in parallel. The vector engine 120 may perform various arithmetic and logical operations such as addition, multiplication, logical operations on vector-type data and the like. The vector engine 120 may be configured in an SIMD ALU (Arithmetic Logic Unit) structure, and each lane may execute the same instruction while being applied to different data. The vector engine 120 may include a register file, a vector-operation lane, and an instruction decoder. The vector engine 120 may also be referred to as an SIMD execution unit, a vector processing unit, a vector arithmetic unit, or the like.

The floating-point unit 130 may perform real-number operations according to a floating-point format such as single-precision or double-precision. It is used for operations requiring higher precision than fixed-point operations, such as addition, subtraction, multiplication, division, square root operations, and the like.

The timing controller 140 may generate control signals among components of the computation accelerator 10 and may deliver operands and control signals at the timing required by the each component. The timing controller 140 may be implemented as a finite state machine, a scheduler, an instruction decoder, a ready signal control unit, or the like. The timing controller 140 may include logic for determining inter-instruction dependencies and controlling whether to insert NOP (No Operation) or an issue timing of an instruction.

The timing controller 140 may determine whether an execution time of an instruction input to the input data manager 100 is fixed or variable. For example, the inner product unit 110 or the floating-point unit 130 may provide, to the timing controller 140, latency information for each instruction, or may provide a ready signal or a busy signal to the timing controller 140. The timing controller 140 may determine, based on the received information or signals, whether an instruction input to the input data manager 100 is a variable-cycle instruction. For example, when a time required for an inner product operation of the instruction or a time required for a vector operation is not constant, and an operation end timing of the instruction varies depending on an operand state, precision, or an external memory response state, the timing controller 140 may determine the instruction as the variable-cycle instruction. The operand state may mean availability or readiness of input data that the instruction refers to or uses. The precision may mean complexity of an operation and a difference in processing time of an operation unit according to a data representation format such as 32-bit floating point or 16-bit floating point. For example, the timing controller 140 may determine whether the instruction is the variable-cycle instruction based on latency information (a latency flag) included in metadata of the instruction.

The timing controller 140 may determine whether an inter-instruction dependency exists for instructions input to the input data manager 100. The inter-instruction dependency may indicate a case where a next instruction depends on an execution result of a current instruction, or a case where the current instruction and the next instruction share the same hardware resource, so that there exists a wait time during which the next instruction is not executed during the execution cycle latency of the current instruction. For example, when output data of the current instruction is used as input data of the next instruction, the timing controller 140 may determine that the dependency exists. For example, when the current instruction and the next instruction share the same operation unit or the same memory interface, the timing controller 140 may determine that the dependency exists.

The timing controller 140 may calculate a wait cycle of an instruction based on a cycle latency. When the wait cycle is greater than 1, the timing controller 140 may enter a wait mode during the wait cycle. The timing controller 140 may receive, from the inner product unit 110 or the vector engine 120, information on the cycle latency of the instruction. The cycle latency information may be defined in a codebook generated in advance.

The timing controller 140 may be referred to as an instruction scheduler, a pipeline controller, a stall manager, a command timing unit or the like.

The timing controller 140 is included in an instruction processing apparatus according to the present disclosure. Additionally, the instruction processing apparatus may include an input unit and an output unit. The input unit acquires instructions of the computation accelerator 10. The instructions sequentially include a current instruction being executed and a next instruction to be executed after the current instruction. The timing controller 140 issues control signals and operands of the instructions. The output unit delivers the control signals and the operands of the instructions to all or a part of the components of the computation accelerator 10.

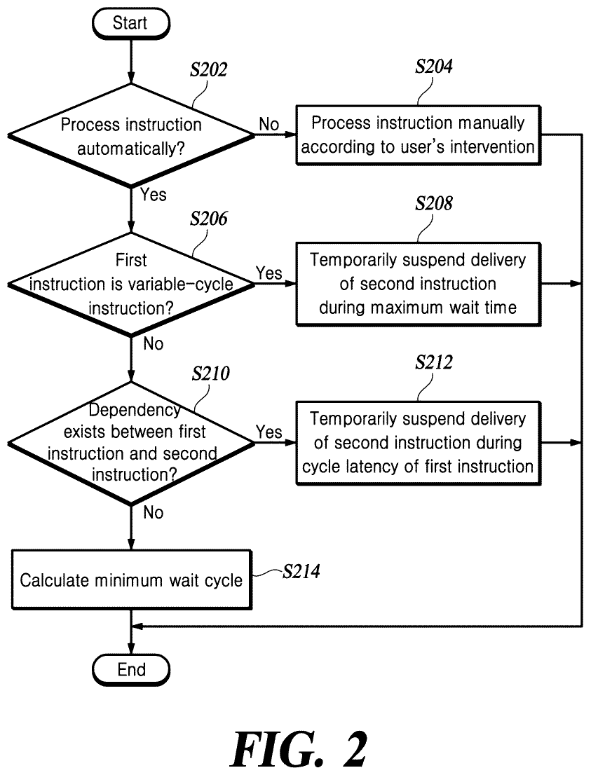

With reference to FIG. 2, an operation sequence in which the instruction processing apparatus sequentially processes operation instructions is described.

Hereinafter, the first instruction represents the current instruction, and the second instruction represents the next instruction.

FIG. 2 is a flowchart schematically showing a process of processing instructions according to an embodiment of the present disclosure.

When processing an instruction according to an embodiment of the present disclosure, the instruction processing apparatus determines whether to automatically process the instruction (S202).

For example, based on a value of a readiness control mode (vme_ready_ctrl_mode) of the vector matrix engine, the instruction processing apparatus may determine whether to automatically process the instruction or to manually process the instruction according to user intervention.

When the instruction is processed manually (No in S202), a user manually processes the instruction according to the user's intervention (S204). For example, when vme_ready indicating a readiness state of the vector matrix engine is always set to ON, and the user may control inter-instruction dependencies by appropriately inserting NOP operation instructions between operation instructions.

When the instruction is processed automatically (Yes in S202), the instruction processing apparatus may automatically process the instruction as follows based on a pre-stored algorithm.

The instruction processing apparatus determines whether the first instruction is a variable-cycle instruction (S206). As described above, the variable-cycle instruction represents an instruction whose end timing is not determined according to data values of operands.

When the first instruction is the variable-cycle instruction (Yes in S206), the instruction processing apparatus temporarily suspends delivery of the second instruction for a maximum wait time (S208).

The instruction processing apparatus suspends delivery of the second instruction, sets a wait cycle (wait_cycle) to the maximum wait time, and enters a wait mode. The maximum wait time is a preset value and, for example, a value greater than an execution cycle latency of the first instruction may be used. After the maximum wait time elapses, the instruction processing apparatus exits the wait mode and issues and delivers the second instruction.

The instruction processing apparatus may enter a wait mode by setting vme_ready, which indicates a readiness state of the vector matrix engine, to 0 during a wait cycle.

When the first instruction is not a variable-cycle instruction (No in S206), the instruction processing apparatus determines whether a dependency exists between the first instruction and the second instruction (S210).

When a dependency exists between the first instruction and the second instruction (Yes in S210), the instruction processing apparatus temporarily suspends delivery of the second instruction during a cycle latency of the first instruction (S212).

For example, the instruction processing apparatus temporarily suspends delivery of the second instruction, sets wait_cycle to curr_instr_cyc-idm_cyc, and enters the wait mode. Here, curr_instr_cyc represents a total execution cycle latency of the first instruction, and idm_cyc represents the cycle latency of the instruction required in the input data controller 100. After the wait_cycle ends, the instruction processing apparatus exits the wait mode and issues and delivers the second instruction.

The instruction processing apparatus may enter a wait mode by setting vme_ready, which indicates a readiness state of the vector matrix engine, to 0 during the wait cycle.

When no dependency exists between the first instruction and the second instruction (No in S210), the instruction processing apparatus calculates a minimum wait cycle between the first instruction and the second instruction (S214).

The instruction processing apparatus may enter a wait mode by setting vme_ready, which indicates a readiness state of the vector matrix engine, to 0 during the wait cycle. After the wait cycle ends, the instruction processing apparatus exits the wait mode and issues and delivers the second instruction.

As described above, curr_instr represents the first instruction currently being executed in the computation accelerator and has a cycle latency for execution completion. The next_instr represents the second instruction executed after the first instruction and depends on an execution result of the first instruction. Alternatively, when sharing the same hardware resources as the first instruction, next_instr may wait for a certain period.

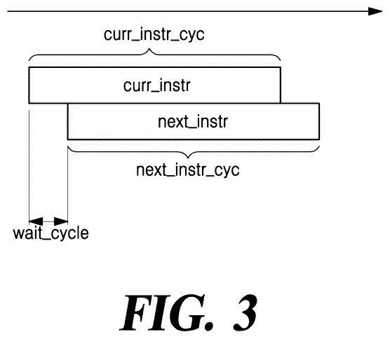

The wait cycle, as shown in FIG. 3, represents the time difference between the time point at which execution of the first instruction is completed and the time point at which the second instruction may be executed. The wait cycle may be calculated based on execution cycle latencies of the two instructions and predefined dependency information. For example, when a result value of the first instruction is used as an input value of the second instruction, the two instructions cannot overlap on a time axis, and the second instruction must be executed only after execution of the first instruction is completed.

The instruction processing apparatus may calculate a minimum wait cycle required between the first instruction and the second instruction as follows.

The total execution cycle latency curr_instr_cyc of the first instruction and total execution cycle latency next_instr_cyc of the second instruction are defined as Equation 1

$$curr\_instr \_cyc = ( idm\_cyc + curr\_dpu \_cyc + curr\_ve \_cyc + odm\_cyc ) \qquad [ Equation 1 ]$$

$$next\_instr \_cyc = ( idm\_cyc + next\_dpu \_cyc + next\_ve \_cyc + odm\_cyc )$$

Here, idm_cyc represents the cycle latency of instructions required in the input data controller 100, and odm_cyc represents the cycle latency of instructions required in the output data controller 160. curr_dpu_cyc and next_dpu_cyc represent a cycle latency of the first instruction and a cycle latency of the second instruction required in the inner product unit 110, respectively. Hereinafter, curr_dpu_cyc and next_dpu_cyc are referred to as a first inner product latency and a second inner product latency, respectively. curr_ve_cyc and next_ve_cyc represent a cycle latency of the first instruction and a cycle latency of the second instruction required in the vector engine 120, respectively. Hereinafter, curr_ve_cyc and next_ve_cyc are referred to as a first vector-operation latency and a second vector-operation latency, respectively.

A wait cycle w0 related to the inner product unit 110 is defined as Equation 2.

$$w 0 = curr\_dpu \_cyc - next\_dpu \_cyc \qquad [ Equation 2 ]$$

As in Equation 3, w0 is clipped to a value of 0 or greater.

$$w {0}^{′} = w 0 if w 0 > 0 , else 0 \qquad [ Equation 3 ]$$

By additionally taking the vector engine 120 into consideration, a wait cycle w1 is defined as in Equation 4.

$$w 1 = ( curr\_dpu \_cyc + curr\_ve \_cyc ) - ( next\_dpu \_cyc + next\_ve \_cyc + w {0}^{′} ) \qquad [ Equation 4 ]$$

As shown in Equation 5, the wait cycle w1 is clipped to a value equal to or greater than 0.

$$w {1}^{′} = w 1 if w 1 > 0 , else 0 \qquad [ Equation 5 ]$$

Finally, as shown in Equation 6, a minimum wait cycle wait_cycle may be calculated based on the clipped values w0′ and w1′.

$$wait\_cycle = w {0}^{′} + w {1}^{′} + 1 \qquad [ Equation 6 ]$$

Based on the wait cycle calculated as described above, the instruction processing apparatus may configure scheduling for sequentially executing instructions.

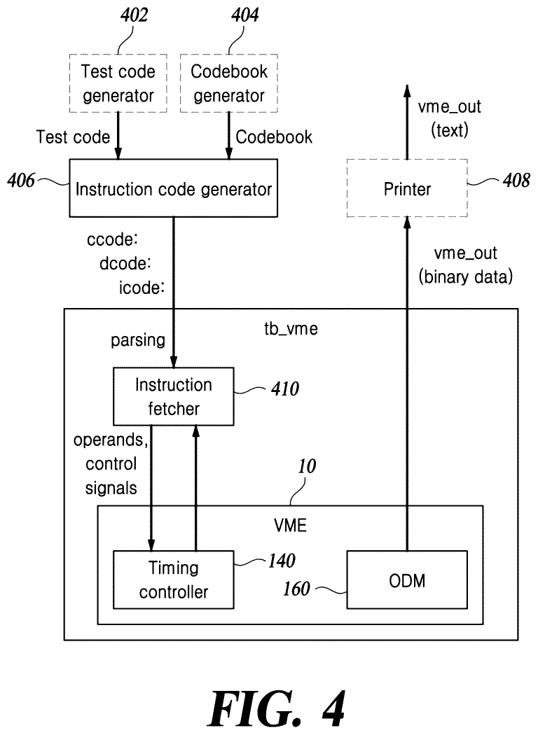

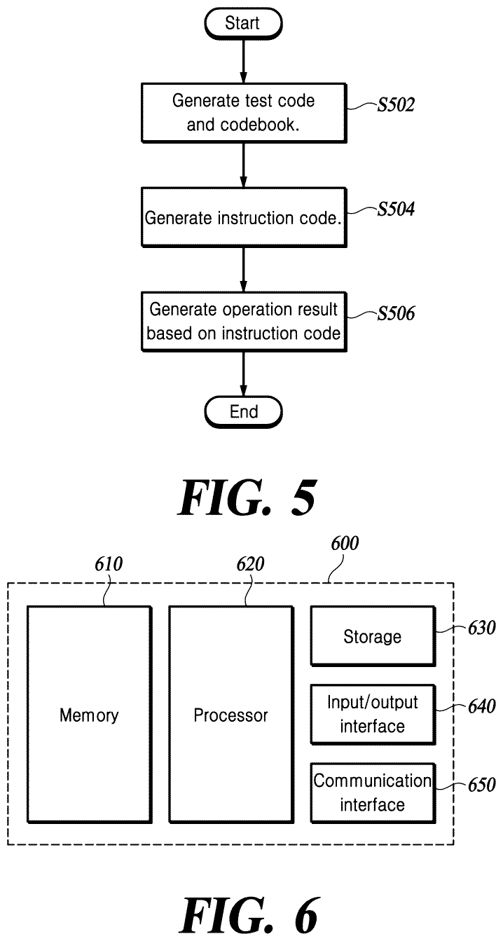

Hereinafter, with reference to FIGS. 4 and 5, an apparatus and a method (hereinafter, referred to as a “verification apparatus and method”) for verifying a structure of the computation accelerator 10 and a method for instruction processing according to the present disclosure are described.

FIG. 4 is an exemplary diagram schematically showing a verification apparatus according to an embodiment of the present disclosure.

The verification apparatus according to the present disclosure includes a testbed of the computation accelerator 10 and external components of the testbed. The testbed includes an instruction fetcher 410 and the computation accelerator 10. In FIG. 4, “tb_vme” denotes the testbed.

The external components include one or more of a test code generator 402, a codebook generator 404, an instruction code generator 406, and a printer 408.

For example, the instruction fetcher 410 and the external components are elements that may be configured by software, and the computation accelerator 10 is configured by hardware.

The test code generator 402 defines operation instructions and related parameters. For example, operations such as gemv (general matrix-vector multiplication), pASU (vector addition/synthesis operation), and the likemay be defined. Parameters, that is, operands (OpA, OpB, . . . ), are randomly generated, and the verification apparatus may simulate an operation process by using the random parameters. An example of the test code is as follows.
gemv, OpA=rand(1, 16), OpB= . . .
pASU, OpA=rand(1, 4), OpB= . . .

The codebook generator 404 defines a codebook including information such as an instruction identification (ID), an instruction name, DPU control signals, VE control signals, and the like. The codebook generator 404 generates a codebook for all instructions of the computation accelerator 10. The control signals and IDs of the respective instructions defined in the codebook generator 404 may be used for instruction code generation. An example of the codebook is shown in Table 1.

TABLE 1

| ID | name | dpu_ctrl0 | ve_ctrl0 | . . . |
|---|---|---|---|---|
| 0x00 | gemm | 0x03 | 0x01 | . . . |
| 0x01 | gemv | . . . | | |
| 0x01 | pASU | . . . | | |
| . . . | | | | |

Here, gem* represents a matrix-vector operation, and pASU represents a vector synthesis operation. dpu_c* and ve_c* represent the DPU control signal and VE control signal, respectively.

The instruction code generator 406 generates executable instruction codes based on the test code and the codebook. The instruction codes include icode, dcode, and ccode, which respectively represent an instruction, operand information, and control signal information. For example, when gemv is used as instruction 1 and fpu is used as instruction 2, icode may be generated as follows.
icode:0x01//gemv
icode:0x24//fpu
. . .

The instruction code generator 406 delivers the instruction codes to the instruction fetcher 410 of the testbed.

The instruction fetcher 410 sequentially parses the instruction codes to generate operands and control signals, and delivers the generated operands and control signals to the timing controller 140 in the computation accelerator 10. The timing controller 140 processes the instructions based on analysis of the operands and control signals, thereby determining operation timings of components in the computation accelerator 10.

The computation accelerator 10 generates an operation result (vme_out), and the generated operation result is delivered to the printer 408 by the output data manager 160. The operation result may be data of a binary type.

The printer 408 converts the operation result into a matrix form to generate an operation result in a text form. The verification apparatus checks whether the operation result is identical to an expected result value. The expected result value is an operation result that the instruction has to perform based on an operation instruction and parameters defined in the test code, and may be obtained by using a simulation environment or a reference model.

FIG. 5 is a flowchart schematically showing a verification method according to an embodiment of the present disclosure.

The verification apparatus generates a test code and a codebook (S502).

The verification apparatus generates executable instruction codes based on the test code and the codebook (S504).

As described above, the instruction codes may include icode, dcode, and ccode. The instruction codes may be converted into a format interpretable by the computation accelerator 10. The instruction codes are delivered to the testbed.

The verification apparatus generates an operation result based on the instruction codes by using the testbed (S506).

The instruction fetcher 410 in the testbed parses the instruction codes to generate operands and control signals, and delivers the operands and control signals to the timing controller 140 in the computation accelerator 10. The timing controller 140 processes the instructions based on analysis of the operands and control signals, thereby determining operation timings of components in the computation accelerator 10. The computation accelerator 10 performs an operation corresponding to the instruction codes to generate an operation result. The operation result is data of a binary type.

The verification apparatus converts the operation result into a matrix form to generate an operation result in a text form, and checks whether the operation result is identical to the expected result value.

The verification method according to the present disclosure shortens verification time by automating an entire process from test code generation to actual hardware operation. By defining instructions flexibly using the codebook, scalability is improved. In addition, the matrix computation accelerator may be rapidly verified without using a complex general-purpose or specialized compiler. The verification method described above efficiently evaluates performance and stability of the matrix computation accelerator and provides reliability in actual applications.

FIG. 6 is a block diagram schematically showing an exemplary computing device that may be used to implement the apparatuses and methods described in the present disclosure.

The computing device 600 may include all or part of a memory 610, a processor 620, storage 630, an input/output interface 640, and a communication interface 650. The computing device 600 may structurally and/or functionally include at least a portion of the verification apparatus. The computing device 600 may be a stationary computing device, such as a desktop computer or a server, as well as a mobile computing device, such as a laptop computer, a smartphone, or an automotive electronic device. The computing device 600 may be implemented as an arbitrarily specialized hardware accelerator capable of efficiently processing operations devised for an artificial intelligence model. For example, the computing device 600 may include a graphics processing unit (GPU), a Tensor Processing Unit (TPU), or a neural processing unit (NPU).

The memory 610 may store a program that enables the processor 620 to perform methods or operations according to various embodiments of the present disclosure. For example, a program may include a plurality of instructions executable by the processor 620, and the methods or operations described above may be performed by executing the plurality of instructions by the processor 620. The memory 610 may consist of a single memory or a plurality of memories. In this case, information required to perform the methods or operation according to various embodiments of the present disclosure may be stored in a single memory or distributed across a plurality of memories. When the memory 610 is composed of a plurality of memories, the plurality of memories may be physically separated. The memory 610 may include at least one of volatile memory and non-volatile memory. Volatile memory includes Static Random Access Memory (SRAM) or Dynamic Random Access Memory (DRAM), while non-volatile memory includes flash memory.

The processor 620 may include at least one core capable of executing at least one instruction. The processor 620 may execute instructions stored in the memory 610. The processor 620 may consist of a single processor or a plurality of processors.

The storage 630 maintains stored data even if power supplied to the computing device 600 is cut off. For example, the storage 630 may include non-volatile memory or may include a storage medium such as a magnetic tape, an optical disk, or a magnetic disk. A program stored in the storage 630 may be loaded into the memory 610 before being executed by the processor 620. The storage 630 may store files written in a program language, and a program created from the files by a compiler may be loaded into the memory 610. The storage 630 may store data to be processed by the processor 620 and/or data processed by the processor 620.

The input/output interface 640 may provide an interface with an input device such as a keyboard or a mouse and/or an output device such as a display device or a printer. The user may trigger execution of a program by the processor 620 through the input device and/or check the processing results of the processor 620 through the output device.

The communication interface 650 may provide access to an external network. The computing device 600 may communicate with other devices through the communication interface 650.

Each component of the apparatus or method according to the present disclosure may be implemented as hardware or software or implemented as a combination of hardware and software. Further, a function of each component may be implemented as software, and a microprocessor may also be implemented to execute the function of the software corresponding to each component.

Various implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. Computer programs (which are also known as programs, software, software applications, or code) contain instructions for a programmable processor and are stored in a “computer-readable recording medium.”

The computer-readable recording medium includes any type of recording device on which data that can be read by a computer system are recordable. Examples of the computer-readable recording medium include non-volatile or non-transitory media such as a ROM, CD-ROM, magnetic tape, floppy disk, memory card, hard disk, optical/magnetic disk, storage devices, and the like. Further, the computer-readable recording medium can be distributed in computer systems connected via a network, wherein the computer-readable codes can be stored and executed in a distributed mode.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

What is claimed is:

1. An apparatus for instruction processing comprising:
an input unit configured to acquire instructions of a computation accelerator, wherein the instructions comprise a first instruction and a second instruction executed after the first instruction;
a timing controller configured to issue control signals of the instructions; and
an output unit configured to deliver the control signals of the instructions to all or a part of components within the computation accelerator,
wherein the timing controller is configured to:
calculate a wait cycle of the second instruction based on whether the first instruction is a variable-cycle instruction, or, when the first instruction is not the variable-cycle instruction, based on whether there is a dependency between the first instruction and the second instruction, and
issue a control signal of the second instruction based on the wait cycle.

2. The apparatus for instruction processing according to claim 1, wherein the timing controller is configured to determine whether the first instruction is the variable-cycle instruction based on an end timing of the first instruction according to an operand value of the first instruction.

3. The apparatus for instruction processing according to claim 1, wherein. when the first instruction is the variable-cycle instruction, the timing controller is configured to determine the wait cycle as a preset maximum wait time and to issue the control signal of the second instruction based on the maximum wait time.

4. The apparatus for instruction processing according to claim 1, wherein, when the first instruction is not the variable-cycle instruction, the timing controller is configured to determine whether the dependency exists based on whether the second instruction depends on an execution result of the first instruction or whether the first instruction and the second instruction share the same hardware resource.

5. The apparatus for instruction processing according to claim 1, wherein, when the first instruction is not the variable-cycle instruction and the dependency exists, the timing controller is configured to set the wait cycle based on a cycle latency of the first instruction.

6. The apparatus for instruction processing according to claim 1, wherein, when the first instruction is not the variable-cycle instruction and the dependency does not exist, the timing controller is configured to calculate the wait cycle based on the cycle latency of the first instruction and a cycle latency of the second instruction.

7. The apparatus for instruction processing according to claim 6, wherein the computation accelerator comprises:
an inner product unit configured to perform an inner product operation based on the control signals; and
a vector engine configured to perform a vector operation based on the control signals,
wherein the cycle latency of the first instruction comprises a first inner product latency which is a time during which the first instruction is executed in the inner product unit, and a first vector-operation latency which is a time during which the first instruction is executed in the vector engine, and
the cycle latency of the second instruction comprises a second inner product latency which is a time during which the second instruction is executed in the inner product unit, and a second vector-operation latency which is a time during which the second instruction is executed in the vector engine.

8. The apparatus for instruction processing according to claim 7, wherein the wait cycle is determined based on a first wait cycle and a second wait cycle,
wherein the first wait cycle is calculated based on the first inner product latency and the second inner product latency, and
the second wait cycle is calculated based on all or a part of the first inner product latency, the first vector-operation latency, the second inner product latency, the second vector-operation latency, and the first wait cycle.

9. A computation accelerator comprising:
a timing controller configured to issue control signals of instructions, wherein the instructions comprise a first instruction and a second instruction executed after the first instruction;
an inner product unit configured to perform an inner product operation based on the control signals; and
a vector engine configured to perform a vector operation based on the control signals,
wherein the timing controller is configured to:
calculate a wait cycle of the second instruction based on whether the first instruction is a variable-cycle instruction, or, when the first instruction is not the variable-cycle instruction, based on whether there is a dependency between the first instruction and the second instruction, and
issue a control signal of the second instruction based on the wait cycle.
